(19) United States
(12) Patent Application Publication
(10) Pub. No.: US 2015/0020012 A1
(43) Pub. Date: Jan. 15, 2015

(54) ELECTRONIC DEVICE AND INPUT METHOD EDITOR WINDOW ADJUSTMENT METHOD THEREOF

(71) Applicant: HTC CORPORATION, TAOYUAN CITY (TW)

(72) Inventor: An-Li WANG, TAOYUAN CITY (TW)

(21) Appl. No.: 13/939,917

(22) Filed: Jul. 11, 2013

(51) Int. Cl. G06F 3/0481

(52) U.S. Cl. CPC G06F 3/0481
USPC 715/768

(57) ABSTRACT

An electronic device and an input method editor window adjustment method thereof are provided. The electronic device comprises a touch screen and a processor, wherein the touch screen is electrically connected to the processor. The processor is configured to display an input method editor window, wherein the transparency of the input method editor window is a first transparency percentage. The processor increases the transparency of the input method editor window until the transparency reaches a second transparency percentage after an input silence time, wherein the second transparency percentage is smaller than 100%.

### CROSS-REFERENCES TO RELATED APPLICATIONS

Not applicable.

### BACKGROUND OF THE INVENTION

1. Field of the Invention

The present invention relates to an electronic device and an input method editor window adjustment method thereof. More particularly, the present invention provides an electronic device and an input method editor window adjustment method thereof that dynamically adjust the transparency of an input method editor window.

2. Descriptions of the Related Art

Various electronic devices (e.g., conventional mobile phones, smart phones, notebook computers, tablet computers, etc.) have become indispensable to everyday lives of modern people. Almost all electronic device manufacturers have tried to design electronic devices to keep up with consumer needs. For example, electronic devices may be integrated with touch screens to sense touch or the proximity of the users' fingers or touch objects (e.g., styluses) so that users can interact with electronic devices via the touch screens. Due to the integration of electronic devices and touch screens, conventional physical input keypads have been gradually replaced by various input method editors displayed on the touch screens, of which an example is the software keypad (also known as the “screen keypad”) displayed on the touch screen. On the other hand, with the development of projection technologies, projection interfaces can also be integrated with electronic devices. Then, electronic devices can display the various input method editors through projection so that the users can interact with the electronic devices through the projection keypads.

Conventional electronic devices, no matter whether they adopt screen keypads or projection keypads, have problems with power consumption. Therefore, reducing the power consumption of the screen keypads or the projection keypads of electronic devices have become an important consideration factor.

On the other hand, a problem is that the input method editor windows displayed on the touch screen may cover information originally displayed on the touch screen. Consequently, when a user uses the input method editor on the touch screen, it will be impossible for the user to read the original information from the touch screen simultaneously. Therefore, the user has to alternately open and close the input method editor windows to read the information displayed on the touch screen simultaneously during the process of using the input method editor window to input data on the touch screen. In other words, it is inconvenient to switch between information display and data input on the touch screen for conventional electronic devices.

Accordingly, an urgent need exists in the art to improve conventional electronic devices so that power consumption of the screen keypads or the projection keypads can be reduced and the switching between the displaying and data input on the touch screen can be more convenient.

### SUMMARY OF THE INVENTION

The primary objective of the present invention is to overcome the problems of conventional electronic devices in which a screen keypad thereof or a projection keypad thereof has too high of a power consumption and the switch between the information display and data input on the touch screen is inconvenient. In particular, the present invention can progressively adjust the transparency of an input method editor window when the user stops using the input method editor window. By adjusting the transparency of the input method editor window, the luminosity of the input method editor window can be effectively reduced to reduce the power consumption thereof. Furthermore, by adjusting the transparency of the input method editor window, the user can read the information displayed on the touch screen during the process of using the input method editor to input data without the need of opening and closing the input method editor window alternately.

To achieve the aforesaid objective, the present invention provides an electronic device. The electronic device comprises a touch screen and a processor electrically connected to the touch screen. The processor is configured to display an input method editor window, wherein transparency of the input method editor window is a first transparency percentage. After an input silence time, the processor increases the transparency of the input method editor window until the transparency reaches a second transparency percentage. The second transparency percentage is smaller than 100%.

To achieve the aforesaid objective, the present invention further provides an input method editor window adjustment method for use in an electronic device. The electronic device comprises a touch screen and a processor electrically connected to the touch screen. The input method editor window adjustment method comprises the following steps:

(a) enabling the processor to display an input method editor window, wherein transparency of the input method editor window is a first transparency percentage; and

(b) enabling the processor to increase the transparency of the input method editor window after an input silence time until the transparency reaches a second transparency percentage, wherein the second transparency percentage is smaller than 100%.

The detailed technology and preferred embodiments implemented for the subject invention are described in the following paragraphs accompanying the appended drawings for persons skilled in this field to well appreciate the features of the claimed invention.

### BRIEF DESCRIPTION OF THE DRAWINGS

FIG. 1 is a schematic view illustrating an electronic device 1 according to the first embodiment of the present invention;

FIG. 2A is a schematic view illustrating a background window 11a of a touch screen 11 according to the first embodiment of the present invention;

FIG. 2B is a schematic view illustrating the touch screen 11 according to the first embodiment of the present invention when transparency of an input method editor window 11b is 0%;

FIG. 2C is a schematic view illustrating the touch screen 11 according to the first embodiment of the present invention when the transparency of the input method editor window 11b is 30%;

FIG. 2D is a schematic view illustrating the touch screen 11 according to the first embodiment of the present invention when the transparency of the input method editor window 11b is 60%;

FIG. 2E is a schematic view illustrating the touch screen 11 according to the first embodiment of the present invention when the transparency of the input method editor window 11b is 90%;

FIG. 3 is a schematic view illustrating an electronic device 3 according to a second embodiment of the present invention; and

FIG. 4 is a flowchart diagram of an input method editor window adjustment method according to a third embodiment of the present invention.

### DESCRIPTION OF THE PREFERRED EMBODIMENT

The present invention can be explained with reference to the following embodiments. However, these embodiments are not intended to limit the present invention to any specific environments, applications or implementations described in these embodiments. Therefore, the description of these embodiments is only for the purpose of illustration rather than to limit the present invention. In the following embodiments and attached drawings, elements not directly related to the present invention are omitted from depiction; and dimensional relationships among individual elements in the attached drawings are illustrated only for ease of understanding but not to limit the actual scale.

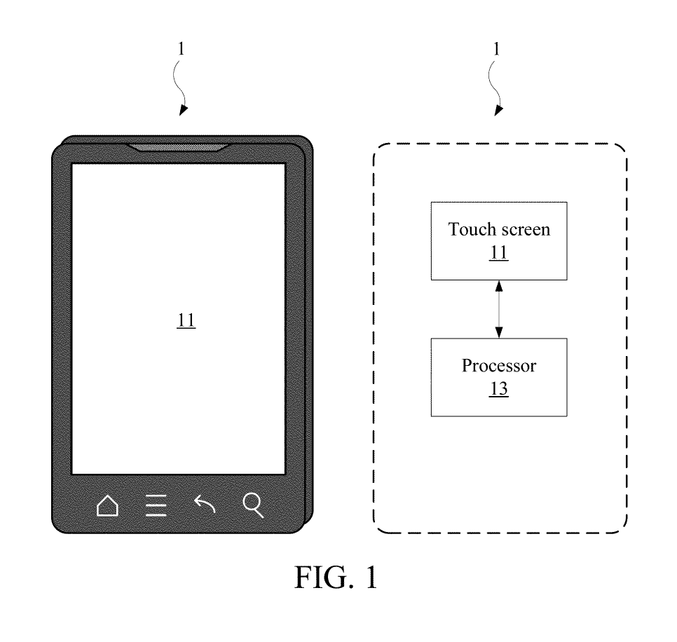

A first embodiment of the present invention is as shown in FIG. 1, which depicts an electronic device 1 of the present invention. As shown in FIG. 1, the electronic device 1 may be a mobile phone, which at least comprises a touch screen 11 and a processor 13 electrically connected to the touch screen 11. In other embodiments, the electronic device 1 may be some other device, for example, but not limited to a device with a touch screen such as a notebook computer, a tablet computer, a personal digital assistant (PDA) and a digital camera.

The touch screen 11 may have different implementations, for example, but not limited to, a capacitive touch screen, a resistive touch screen, a resistive-capacitive composite touch screen, an electromagnetic-induction touch screen, etc. The processor 13, which may be electrically connected to the touch screen 11 directly or indirectly, is configured to communicate with the touch screen 11 and control the touch screen 11 to execute various operations. The electronic device 1 may comprise other components, modules and interfaces; however, those not directly related to the present invention are all omitted from depiction.

The processor 13 can display an input method editor (IME) window on the touch screen 11. The transparency of the input method editor window is a first transparency percentage. After an input silence time, the processor 13 can gradually increase the transparency of the input method editor window until the transparency reaches a second transparency percentage. The second transparency percentage is smaller than 100%.

Hereinafter, the various operations executed by the processor 13 and the touch screen 11 will be further described with reference to an example. In this example, suppose that the user of the electronic device 1 opens an e-mail and is going to reply to the sender of the e-mail.

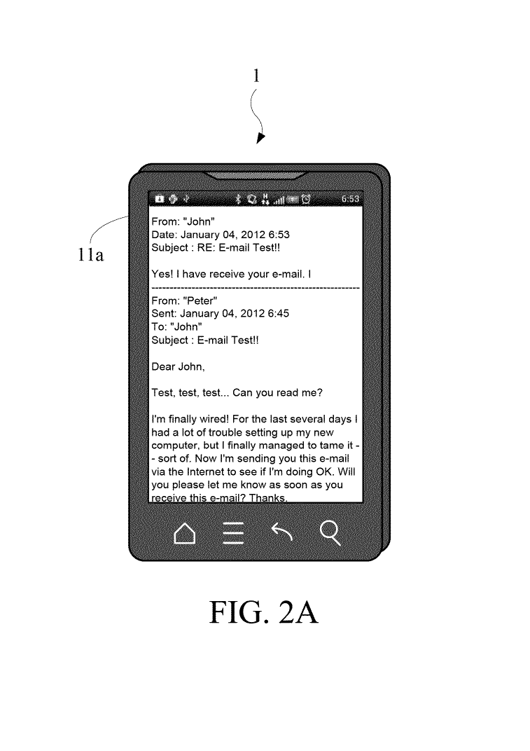

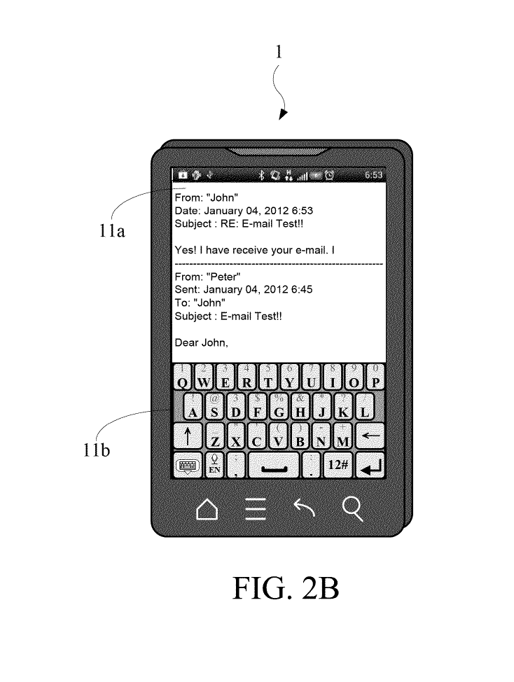

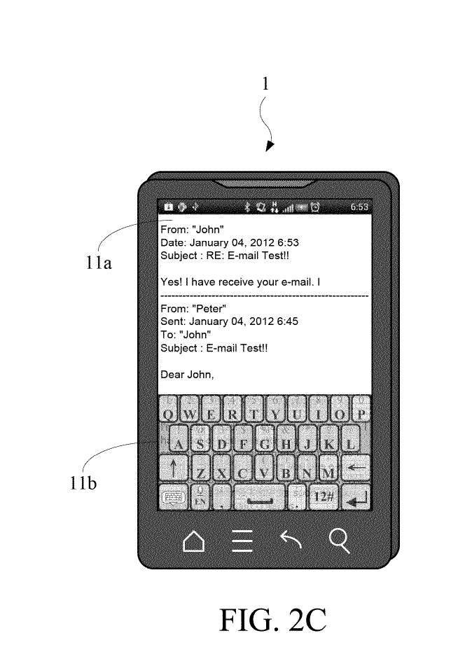

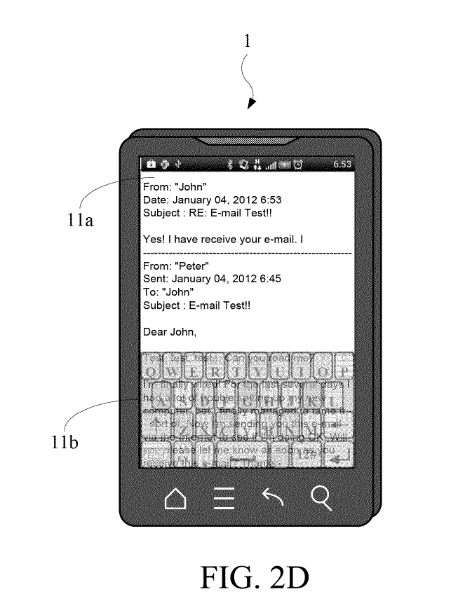

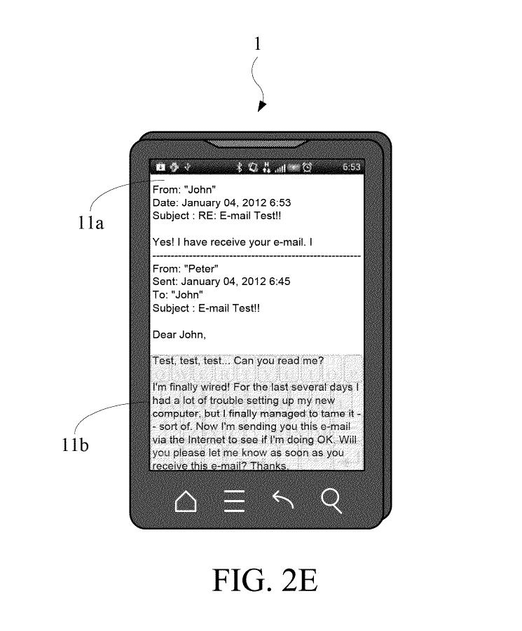

As shown in FIG. 2A, when the user of the electronic device 1 opens the e-mail, the processor 13 displays a background window 11a on the touch screen 11. The background window 11a is configured to display a related message of the e-mail, which includes, but is not limited to a sending date, a sender, a copy, an appendix, mail contents, and so on. As shown in FIG. 2B, when the user of the electronic device 1 is going to reply to the sender of the e-mail, the user enables an input method editor window 11b to be displayed on the touch screen 11 by touching the physical input method editor activating key disposed on the electronic device 1 or by touching/approaching a corresponding activating icon on the touch screen 11, wherein the input method editor window 11b at least covers a part of the background window 11a. In this embodiment, the input method editor window 11b is a keypad input window. However, in other embodiments, the input method editor window 11b may also be a handwriting input window or various input method editor windows well known by those of ordinary skill in the art.

In response to the aforesaid activation by the user, the transparency of the input method editor window 11b that is displayed on the touch screen 11 at this point may be a first transparency percentage. The first transparency percentage (i.e., the initial transparency percentage) may be set as a percentage between 0% and 10% to allow the user to clearly see the key icons on the input method editor window 11b. In other embodiments, the initial transparency percentage may also be between 0% and 20% or between 10% and 20%. In addition, the first transparency percentage may be preferably set as 0%. The key icons displayed on the input method editor window 11b may include but are not limited to a character key icon, a function key icon, an edition key icon, a shortcut key icon, etc.

After the user activates and displays the input method editor window 11b on the touch screen 11, the user can use a finger or some other touch object (e.g., a stylus) to touch/approach each of the key icons displayed on the input method editor window 11b to input the information.

When the input method editor window 11b is not touched by the user for a time period (i.e., after an input silence time), the processor 13 determines that the user may want to read the related message of the e-mail displayed on the background window 11a currently. Then, the processor 13 gradually increases the transparency of the input method editor window 11b to make the input method editor window 11b become transparent gradually so that the part of the background window 11a that was originally covered by the input method editor window 11b can be gradually seen by the user of the electronic device 1. At this point, because the input method editor window 11b becomes gradually transparent, the display brightness of the input method editor window 11b can be lowered to reduce the power consumption. The input silence time may be set by the designer according to different circumstances, and may be set as, for example, but is not limited to 5 seconds, 10 seconds, 15 seconds, etc.

In this embodiment, the processor 13 may increase the transparency of the input method editor window 11b every identical waiting time interval until the transparency reaches a second transparency percentage. The waiting time interval may be set as but is not limited to 1 second, 1.5 seconds, 2 seconds, 2.5 seconds, 3 seconds, etc. In other embodiments, the processor 13 may also increase the transparency of the input method editor window 11b every variable waiting time interval. For example, the first interval is 3 seconds, the second interval is 2 seconds, the third interval is 1.5 seconds, etc

In this embodiment, the second transparency percentage is 90%. The purpose of setting the second transparency percentage as 90% is to allow the user to still see the input method editor window 11b faintly even if he has not touched the input method editor window 11b for a time period. In other words, the second transparency percentage must be smaller than 100%. In other embodiments, the second transparency percentage may be set by the designer according to different circumstances, for example, but is not limited to 95%, 85%, 80%, etc.

In this embodiment, the processor 13 gradually increases the transparency percentage of the input method editor window 11b by an increment of 30%. FIGS. 2C, 2D and 2E illustrate cases where the transparency percentage of the input method editor window 11b is increased to 30%, 60% and 90% respectively. In other embodiments, the processor 13 may also use 5%, 10%, 15%, 20% or 25% as the increment to gradually increase the transparency of the input method editor window 11b. In other words, the increment of the transparency may be set by the designer according to different circumstances.

As shown in FIG. 2C, the processor 13 increases the transparency of the input method editor window 11b to 30% after an input silence time. At this point, the user can faintly see the related message of the e-mail displayed on the background window 11a. Then, as shown in FIG. 2D, the processor 13 increases the transparency of the input method editor window 11b to 60% after a waiting time. At this point, the user can generally see the related message of the e-mail displayed on the background window 11a. Finally, as shown in FIG. 2E, the processor 13 increases the transparency of the input method editor window 11b to 90% after another waiting time. At this point, the user can almost completely see the related message of the e-mail displayed on the background window 11a.

In this embodiment, in the process of gradually increasing the transparency of the input method editor window 11b, the processor 13 can further immediately adjust the transparency of the input method editor window 11b into the first transparency percentage (i.e., the initial transparency percentage) in response to the user input at any time. The first transparency percentage may be set as, for example, but is not limited to a percentage between 0% and 10% or a percentage between 0% and 20%. Preferably, the processor 13 can immediately adjust the transparency of the input method editor window 11b into 0% in response to a user input at any time. The user input may include, but is not limited to the following operations: touching/approaching the input method editor window 11b by a finger or a touch object, touching the physical input method editor activating key disposed on the electronic device 1, or touching/approaching the corresponding activating icon on the touch screen 11.

In this embodiment, the processor 13 gradually increases the transparency of the input method editor window 11b according to an alpha blending parameter. The alpha blending parameter can be used to change the transparency of all windows on the touch screen 11, and each of the windows displayed on the touch screen 11 has its own alpha blending parameter. The alpha blending parameter has a value between 0% and 100%, wherein 0% represents that the window is completely opaque and 100% represents that the window is completely transparent.

The electronic device 1 of this embodiment can not only operate in the case where the user replies to the e-mail. For example, the electronic device 1 may also operate in a case where the user looks through a webpage. When the user uses the electronic device 1 to look through a webpage, the processor 13 displays a background window 11a on the touch screen 11. In this case, the background window 11a is used to display the related message of the webpage. When the user is going to input data (e.g., a website, a login account number, a login password, a network message, etc.) to the electronic device 1 through the input method editor window 11b, the input method editor window 11b displayed on the touch screen 11 also has the aforesaid functions. That is, if the input method editor window 11b has been displayed on the touch screen 11 when the user looks through a webpage, the processor 13 gradually increases the transparency of the input method editor window 11b after an input silence time until the transparency reaches a second transparency percentage.

In this embodiment, the information displayed on the background window 11a is only used as an example to illustrate the present invention, but is not intended to limit the implementations of the present invention. In addition, the type of information (for example, but not limited to patterns, images and characters) that is displayed on the background window 11a has no influence on the practical implementations of the present invention. Further, the implementations of the present invention will not be affected even if no information is displayed on the background window 11a.

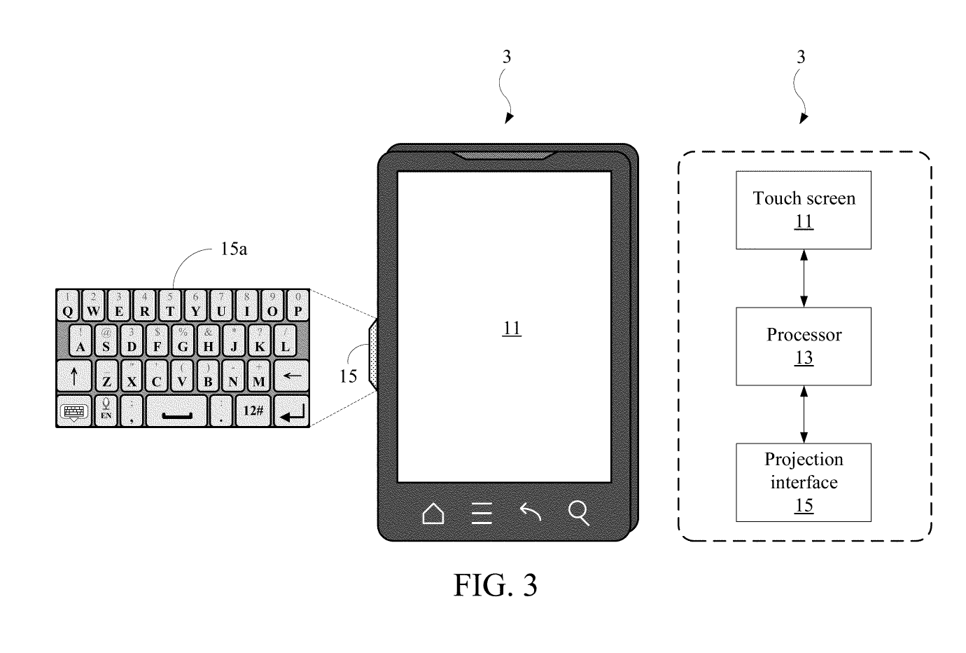

A second embodiment of the present invention is as shown in FIG. 3, which depicts an electronic device 3 of the present invention. As shown in FIG. 1, the electronic device 1 may be a mobile phone, which at least comprises a touch screen 11, a projection interface 15, and a processor 13 electrically connected to the touch screen 11 and the projection interface 15. In other embodiments, the electronic device 1 may be some other device, for example but is not limited to, a device with a projection interface such as a notebook computer, a tablet computer, a PDA and a digital camera, etc.

The electronic device 3 of this embodiment is substantially the same as the electronic device 1 of the first embodiment. Therefore, the components other than those specially described in this embodiment can all be understood as the components corresponding to the electronic device 1 of the first embodiment. Accordingly, the reference numerals and contents of some components identical to those of the first embodiment will still be used in this embodiment, with the same reference numerals representing substantially the same or similar components; and the description of the same technical contents is omitted herein. The omitted description can be known from the aforesaid embodiment and, thus, will not be further described in this embodiment.

As shown in FIG. 3, the electronic device 3 of this embodiment mainly differs from the electronic device 1 of the first embodiment in that the electronic device 3 comprises the projection interface 15 configured to project an input method editor window 15a. More specifically, the electronic device 3 can project the input method editor window 15a so that the user can interact with the electronic device 3 to input data through the input method editor window 15a. The method in which the input method editor window 15a and the electronic device 3 communicate with each other is well known by those of ordinary skill in the art, and thus, will not be further described herein.

The input method editor window 15a of this embodiment is substantially the same as the input method editor window 11b of the first embodiment, and has a first transparency percentage at the beginning of the display. Then the processor 13 can gradually increase the transparency of the input method editor window 15a after an input silence time until the transparency reaches a second transparency percentage, wherein the second transparency percentage is smaller than 100%. For the details about the method in which the processor 13 adjusts the transparency of the input method editor window 15a, please refer to the description in FIG. 2B to FIG. 2E. The electronic device 3 of this embodiment only differs from the electronic device 1 of the first embodiment in how to display the input method editor window while the other features can be viewed as being substantially identical.

Additionally, it shall be noted that the input method editor window 11b displayed on the touch screen 11 of the electronic device 3 and the input method editor window 15a of the projection interface 15 of the electronic device 3 can be displayed simultaneously or alternatively depending on practical applications. Furthermore, in this embodiment, the touch screen 11 of the electronic device 3 may also be replaced by a display unit without a touch function according to practical requirements.

In addition to the aforesaid operations, the electronic device 3 of this embodiment can also execute all the operations of the electronic device 1 set forth in the first embodiment and accomplish all the corresponding functions. The method in which the electronic device 3 of this embodiment executes these operations and accomplishes these functions can be readily appreciated by those of ordinary skill in the art based on the explanation of the first embodiment, and thus will not be further described herein.

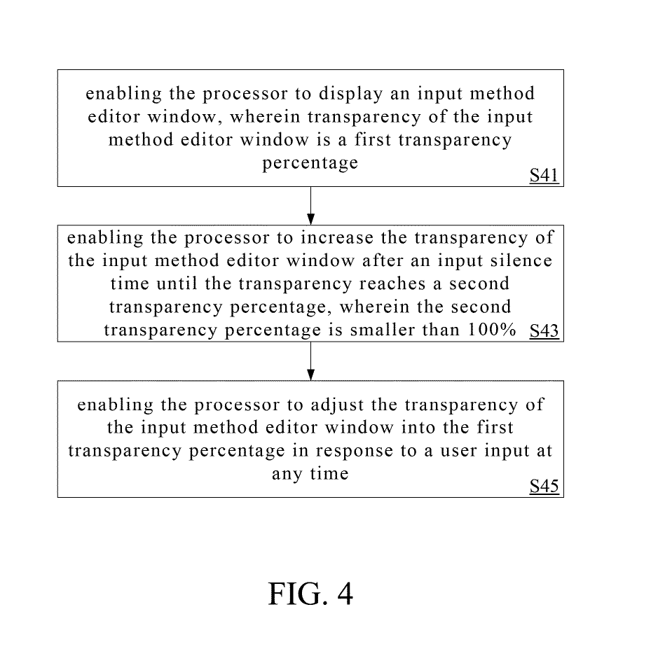

A third embodiment of the present invention is as shown in FIG. 4, which depicts an input method editor window adjustment method of the present invention. The input method editor window adjustment method of this embodiment can be used in an electronic device (e.g., the electronic device 1 of the first embodiment or the electronic device 3 of the second embodiment).

As shown in FIG. 4, step S41 is executed to enable the processor to display an input method editor window, wherein the transparency of the input method editor window is a first transparency percentage. In this embodiment, the processor can display the input method editor window and a background window on the touch screen, and the input method editor window at least covers a part of the background window. In other embodiments, the electronic device further comprises a projection interface electrically connected to the processor, and the processor can display the input method editor window through the projection interface.

Step S43 is executed to enable the processor to increase the transparency of the input method editor window after an input silence time until the transparency reaches a second transparency percentage, wherein the second transparency percentage is smaller than 100%. Optionally, the input method editor window adjustment method of this embodiment may further comprise step S45 of enabling the processor to further adjust the transparency of the input method editor window into the first transparency percentage in response to the user input at any time.

In other embodiments, step S43 may further be executed to enable the processor to gradually increase the transparency of the input method editor window according to an alpha blending parameter.

In other embodiments, step S43 may further be executed to enable the processor to gradually increase the transparency of the input method editor window by an increment of 10%.

In other embodiments, step S43 may further be executed to enable the processor to increase the transparency of the input method editor window every waiting time interval until the transparency reaches the second transparency percentage.

In other embodiments, the input method editor window of this embodiment is a handwriting input window or a keypad input window. In other embodiments, the first transparency percentage of this embodiment is 0%. In other embodiments, the second transparency percentage of this embodiment is 90%.

In addition to the aforesaid steps, the input method editor window adjustment method of this embodiment can also execute all the operations of the electronic device 1 and the electronic device 3 set forth in the aforesaid embodiments and accomplish all the corresponding functions. The method in which the input method editor window adjustment method of this embodiment executes these operations and accomplishes these functions can be readily appreciated by those of ordinary skill in the art based on the explanation of the aforesaid embodiments, and thus will not be further described herein.

According to the above descriptions, the present invention provides an electronic device and an input method editor window adjustment method thereof. The electronic device and the input method editor window adjustment method thereof according to the present invention can progressively adjust the transparency of an input method editor window when the user stops using the input method editor window. By adjusting the transparency of the input method editor window, the luminosity of the input method editor window can be effectively reduced to reduce the power consumption thereof. Furthermore, by adjusting the transparency of the input method editor window, the user can read the information displayed on the touch screen during the process of using the input method editor to input data without the need of alternately opening and closing the input method editor window.

Accordingly, the electronic device and the input method editor window adjustment method thereof according to the present invention can effectively solve the problems of the conventional electronic devices in which the screen keypad thereof or a projection keypad thereof has too high of power consumption and the switch between the information display and data input on the touch screen is inconvenient.

The above disclosure is related to the detailed technical contents and inventive features thereof. Persons skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An electronic device, comprising:
a touch screen; and
a processor electrically connected to the touch screen, being configured to execute the following operations:
displaying an input method editor window, wherein transparency of the input method editor window is a first transparency percentage; and
increasing the transparency of the input method editor window until the transparency reaches a second transparency percentage after an input silence time, wherein the second transparency percentage is smaller than 100%.

2. The electronic device as claimed in claim 1, wherein the processor displays the input method editor window and a background window on the touch screen, and the input method editor window at least covers a part of the background window.

3. The electronic device as claimed in claim 1, further comprising a projection interface electrically connected to the processor, wherein the processor displays the input method editor window through the projection interface.

4. The electronic device as claimed in claim 1, wherein the processor further adjusts the transparency of the input method editor window into the first transparency percentage in response to a user input at any time.

5. The electronic device as claimed in claim 1, wherein the processor increases the transparency of the input method editor window according to an alpha blending parameter.

6. The electronic device as claimed in claim 1, wherein the processor increases the transparency of the input method editor window every waiting time interval until the transparency reaches the second transparency percentage.

7. The electronic device as claimed in claim 1, wherein the input method editor window is one of a handwriting input window and a keypad input window.

8. The electronic device as claimed in claim 1, wherein the first transparency percentage is 0%.

9. The electronic device as claimed in claim 1, wherein the second transparency percentage is 90%.

10. An input method editor window adjustment method for use in an electronic device, the electronic device comprising a touch screen and a processor electrically connected to the touch screen, the input method editor window adjustment method comprising the following steps of:
(a) enabling the processor to display an input method editor window, wherein transparency of the input method editor window is a first transparency percentage; and
(b) enabling the processor to increase the transparency of the input method editor window after an input silence time until the transparency reaches a second transparency percentage, wherein the second transparency percentage is smaller than 100%.

11. The input method editor window adjustment method as claimed in claim 10, wherein the processor displays the input method editor window and a background window on the touch screen, and the input method editor window at least covers a part of the background window.

12. The input method editor window adjustment method as claimed in claim 10, wherein the electronic device further comprises a projection interface electrically connected to the processor, wherein the processor displays the input method editor window through the projection interface.

13. The input method editor window adjustment method as claimed in claim 10, further comprising the following step of:
(c) enabling the processor to adjust the transparency of the input method editor window into the first transparency percentage in response to a user input at any time.

14. The input method editor window adjustment method as claimed in claim 10, wherein the processor increases the transparency of the input method editor window according to an alpha blending parameter.

15. The input method editor window adjustment method as claimed in claim 10, wherein the processor increases the transparency of the input method editor window every waiting time interval until the transparency reaches the second transparency percentage.

16. The input method editor window adjustment method as claimed in claim 10, wherein the input method editor window is one of a handwriting input window and a keypad input window.

17. The input method editor window adjustment method as claimed in claim 10, wherein the first transparency percentage is 0%.

18. The input method editor window adjustment method as claimed in claim 10, wherein the second transparency percentage is 90%.
